(19) United States
(12) Patent Application Publication
(10) Pub. No.: US 2018/0242764 A1
(43) Pub. Date: Aug. 30, 2018

(54) Multi-handled Adaptable Sleeve for Drinking Containers

(71) Applicant: Douglas Ming-Li Wynne, Airdrie (CA)

(72) Inventor: Douglas Ming-Li Wynne, Airdrie (CA)

(21) Appl. No.: 15/884,355

(22) Filed: Jan. 30, 2018

Related U.S. Application Data
(63) Continuation of application No. 62/454,783, filed on Feb. 4, 2017.

(51) Int. Cl. A47G 23/02; B65D 25/28; A61J 9/06; A61J 17/02

(52) U.S. Cl. CPC A47G 23/0216; A61J 17/02; A61J 9/0623; B65D 25/2802

(57) ABSTRACT

Aspects of the invention include an improved, adaptable sleeve for attaching at least one handle which can accommodate a range of containers of varying shape, size or material compositions. In certain embodiments, the sleeve has one or more protrusions having ergonomic features to assist holding the container upon which the sleeve is installed. In certain embodiments the sleeve is comprised of an elastomer material. In certain embodiments the sleeve is comprised of an expandable, corrugated sleeve wall to receive, conform and adapt to a range of containers. In certain embodiments the sleeve provides improved grasping and control functionality for infants, and users with limited grasping capabilities due to youth, injury or other impairments or restrictions. Accordingly, in certain embodiments the sleeve is silicone with the protruding elements configured to function both as a grasping and control aid for the container and a safe teething chew accessory for infants.

### CROSS-REFERENCE TO RELATED APPLICATIONS

This application claims priority to and the benefit of U.S. Provisional Application Ser. No. 62/454,783, filed on Feb. 4, 2017 and entitled “Multi-handled Adaptable Sleeve for Drinking Containers” which is Incorporated by reference herein in its entirety.

### BACKGROUND OF THE INVENTION

Existing bottles, cups and other drinking type containers comprise a wide variety of shapes, sizes, materials and weights. These include, but are not limited to baby bottles, drinking cups, teething cups, sippy cups, spout cups, straw cups, novelty cups, water bottles, juice boxes, reusable squeeze pouches and other oddly shaped containers designed to be attractive to infants. These containers often become slippery and can be difficult to control for users with limited dexterity due to youth, injury, illness or handicap.

When considering infants between 6 months and 2 years of age, many containers for this age group have a diameter which is too large relative to the size of infant hands, making it difficult for an infant to grasp, control and support them. When the containers are filled, the increase in the overall weight further adds to the challenge of grasping, controlling and supporting the container. Some container manufacturers have opted for a taller design with a smaller diameter to address this challenge; however this raises the center of mass and the potential of the container falling over is far greater, so it is still the most common for container designs to maintain a shorter profile and subsequently larger diameters. Similarly, new vacuum insulated style containers require additional wall thickness dimension to provide the vacuum insulated layer further increasing the outer diameters of containers. These, among other factors such as material, shape and glossy and smooth surface finishes, make it difficult for infants to grasp many of the available containers. As such, most containers require infants to use two hands to pick up, support, grasp and control the container.

Often there is concern from parents with respect to leaching of harmful chemicals into the contents of their infant's container; specifically bisphenol A, phthalates, polyvinyl chlorides and lead. To avoid this risk, an emerging trend is evident where parents are seeking out safe material alternatives for their child's containers. These materials include glass, stainless steels and silicones. In the case of glass and stainless steels the containers are usually heavier when compared to their plastic counterparts and are usually smooth and can be slippery and difficult for an infant to hold. Due to the nature and cost of manufacturing containers out of stainless steel and glass it is also rare to find designs that directly incorporate handles.

Often these containers are essentially cylindrical in shape with a smooth exterior finish and lack a reliable means of securing the container to prevent dropping and potential misplacement or loss of the container. Additionally the cylindrical shape increases the potential for the container to roll away after it has been knocked over, increasing likelihood of damage or loss.

The challenges of picking up these larger diameter containers and the requirement for two handed grasping, control and support can become problematic in several ways. When a parent or more capable individual is unavailable to immediately assist in the event a container is dropped or an infant seeks to pick a container up independently, this common scenario often results in a distraught and frustrated infant. Furthermore when the infant is learning to eat solid foods, if the infant must use and maintain both hands on the container to grasp and stabilize it, they are unable to hold food with an available hand, thus requiring the parent to hold the food and assist the infant during feeding. The requirement for two hands also decreases the effective radius that an infant can pick up a container. In contrast a single outstretched arm significantly increases their effective reach. In circumstances where an infant is in a fixed location, for example when strapped into a car seat, high chair or stroller, this additional range to grasp and pick up a container with a single hand and increased independence can be of significant benefit to the infant as well as the parent.

Other challenges are found specifically with juice box containers where a young child will often lack the grip control or have a tendency to squeeze a juice box which results in a spill of the contents jettisoned through the straw, often creating further problems with the staining of clothing, furniture, carpet and other surroundings. Specifically designed hard plastic handled enclosures are available in an attempt to address this challenge however they are extremely limited in application, by only accepting a specific size of juice box and working only with juice box type containers.

Furthermore as infants grow and develop, many families find they have accumulated an excessive collection of cups, bottles and various containers which were only used for a very short period of time during the very early stages of rapid transitional development. This rapid transition through bottles, to handled sippy cups, spout cups, non-handled sippy cups and subsequently adult style cups occurs in a relatively short period of time resulting in underutilized containers. A few manufacturers are attempting to address this issue with containers that are designed to be reconfigured with different accessories as your child grows, however this is limited and only specific to the single product line.

In cases of users with arthritis or other illness that impedes manual dexterity there is a need for an accessory that can be easily fitted to provide greater means of control of a range of containers and assist with the supporting of and holding of containers. The inability to self-feed and grasp a container can prove to be extremely frustrating and the lack of independence can have severe negative impacts on the mental state and health of users facing these challenges.

Accordingly, there is a need in the art for a multi-handled adaptable container sleeve that is readily securable to the wide range of various sizes, shapes and materials of containers; with handles that can be fitted with relative ease and easily secured while maintaining a design rigid enough to allow for positive control, and made from a material that is easily cleanable for health reasons. The present invention meets these and other such needs.

### BRIEF SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

Aspects of the invention include an adaptable sleeve with handles and at least one opening to receive containers which is easily installed onto a container despite variations in size, weight, shape or material composition of the container, whereby improving grip, support and control of a container for the user. In certain embodiments, the multi-handled adaptable container sleeve is designed to provide a uniquely shaped silicone sleeve that is able to expand, contract and conform to fit a range of container sizes and shapes while at the same time securely supporting multiple gripping handles for positive control. In certain embodiments, the adaptable sleeve is comprised essentially of silicone. In certain embodiments, the adaptable sleeve is comprised of a corrugated sleeve wall configured for receiving and conforming to a wide range of containers of varying shape, size and material composition and reducing the surface contact area of the sleeve with the exterior of the container during installation. In certain embodiments the adaptable sleeve has a corrugated sleeve wall with axial ridges to further reduce the surface contact area of the interior wall of the sleeve with the exterior of the container during installation. In certain embodiments, the adaptable sleeve includes a handle comprised essentially of silicone and configured to function as a handle for grasping and a teething chew for infants. In certain embodiments the adaptable sleeve comprised of essentially silicone, is easy to use, food safe, microwave safe, dishwasher compatible and able to fit most size of shape of drinking container. In certain embodiments, the adaptable sleeve is comprised of a corrugated sleeve wall which provides improved protection from impacts and damage.

### BRIEF DESCRIPTION OF DRAWINGS

According to common practice, the various features of the drawings may not be drawn to-scale. Rather, the dimensions of the various features may be arbitrarily expanded or reduced for clarity. Included in the drawings are the following figures:

FIG. 1A illustrates an embodiment of a multi-handled adaptable sleeve in accordance with disclosure. FIG. 1A represents a top view of the adaptable sleeve, and FIG. 1B represents a top isometric view.

FIG. 2A illustrates an embodiment of a top end of a multi-handled adaptable sleeve in accordance with disclosure. FIG. 2A represents one view of a multi-handled adaptable sleeve in a contracted state. FIG. 2B represents one view of a multi-handled adaptable sleeve in an expanded state.

FIG. 3 illustrates an embodiment of a multi-handled adaptable sleeve fitted to a glass infant feeding bottle in accordance with disclosure.

FIG. 4 illustrates an embodiment of a multi-handled adaptable sleeve fitted to a cylindrical plastic infant straw cup in accordance with disclosure.

FIG. 5A illustrates an embodiment of a multi-handled adaptable sleeve in accordance with disclosure. FIG. 5A represents one view of a multi-handled adaptable sleeve fitted to a tapered infant sippy cup, and FIG. 5B represents another view.

FIG. 6B illustrates an embodiment of a multi-handled adaptable sleeve in accordance with disclosure. FIG. 6A represents a cross sectional, cutaway view of a multi-handled adaptable sleeve fitted to a plastic hourglass shaped infant straw cup, and FIG. 6B represents another view.

FIG. 7B illustrates an embodiment of a multi-handled adaptable sleeve in accordance with disclosure. FIG. 7A represents a top view of a multi-handled adaptable sleeve fitted to a rectangular juice box container, and FIG. 7B represents another view.

FIG. 8 illustrates a cross sectional, cutaway view of an embodiment of a multi-handled adaptable sleeve with an internal rigid handle structure comprised of stiffer material for load distribution and structural reinforcement of the handles and in accordance with disclosure.

FIG. 9 illustrates a cross sectional, cutaway view of an embodiment of a multi-handled adaptable sleeve with handles essentially comprised of a stiffer material in accordance with disclosure.

FIG. 10 illustrates an embodiment of a single-handled adaptable sleeve in accordance with disclosure.

FIG. 11 illustrates an embodiment of a multi-handled adaptable sleeve with handle elements designed as teething chew elements for infants in accordance with disclosure.

FIG. 12 illustrates an embodiment of a multi-handled adaptable sleeve with protrusions designed with flaps and grip enhancing surface features for infants in accordance with disclosure.

FIG. 13 illustrates an embodiment of a multi-handled adaptable sleeve with a vented sleeve in accordance with disclosure.

FIG. 14B illustrates an embodiment of a multi-handled adaptable sleeve in accordance with disclosure. FIG. 14A represents a top view a multi-handled adaptable sleeve with additional flat wall section for branding, logos and additional contact surface area, and FIG. 14B represents a top isometric view a multi-handled adaptable sleeve with additional flat wall section for branding, logos and additional contact surface area.

FIG. 15A illustrates an embodiment of a multi-handled adaptable sleeve in accordance with disclosure. FIG. 15A represents a top view of a cylindrically shaped sleeve with two handles, and FIG. 15B represents a top view of a cylindrically shaped sleeve with three handles.

### DETAILED DESCRIPTION

Before the present invention is further described, it is to be understood that this invention is not limited to particular embodiments as described, and as such may vary. It is also to be understood that the terminology used herein is for the purpose of describing particular embodiments only, and is not intended to be limiting. Unless defined otherwise, all technical terms used herein have the same meaning as commonly understood by one skilled in the art to which this invention belongs.

It must be noted that as used herein and in the appended claims, the singular forms “a”, “and”, and “the” include plural referents unless the context clearly dictates otherwise. It is further noted that the claims may be drafted to exclude any optional element. The following is merely illustrative of the principles of this invention and various modifications can be made by those skilled in the art without departing from the scope and spirit of the invention.

Aspects of the invention include a multi-handled, adaptable sleeve for attaching at least one handle to a container which can accommodate a range of varying shape, size and material compositions. In certain embodiments, the adaptable sleeve has one or more protrusions having ergonomic features to assist holding the container upon which the sleeve is installed. In certain embodiments the sleeve is comprised of an elastomer material. In certain embodiments the sleeve is comprised of an expandable, corrugated sleeve wall to receive, conform and adapt to a range of containers of varying shapes, sizes or material compositions and reduce the surface contact area between the interior surface of the sleeve and the exterior surface of the container. In certain embodiments the expandable, corrugated sleeve wall further comprises axial ridges along the interior peaks of the corrugated wall flutes whereby further reducing surface contact between the sleeve and container and maintaining a bias for radial expansion of the sleeve over that of axial expansion. In certain embodiments the corrugated sleeve wall and protrusions are a protective sleeve providing improved impact absorption and preventing the container from rolling away if it is knocked over. In certain embodiments the sleeve provides improved grasping and control functionality for infants, or users with limited grasping capabilities due to injuries or other restrictions. Accordingly, in certain embodiments the sleeve is silicone with the protruding elements configured to function both as a grasping aid for the container and a safe teething chew accessory for infants.

Various embodiments of the subject invention will now be described with reference to the figures. Then how each element functions and interacts with each other element will be described.

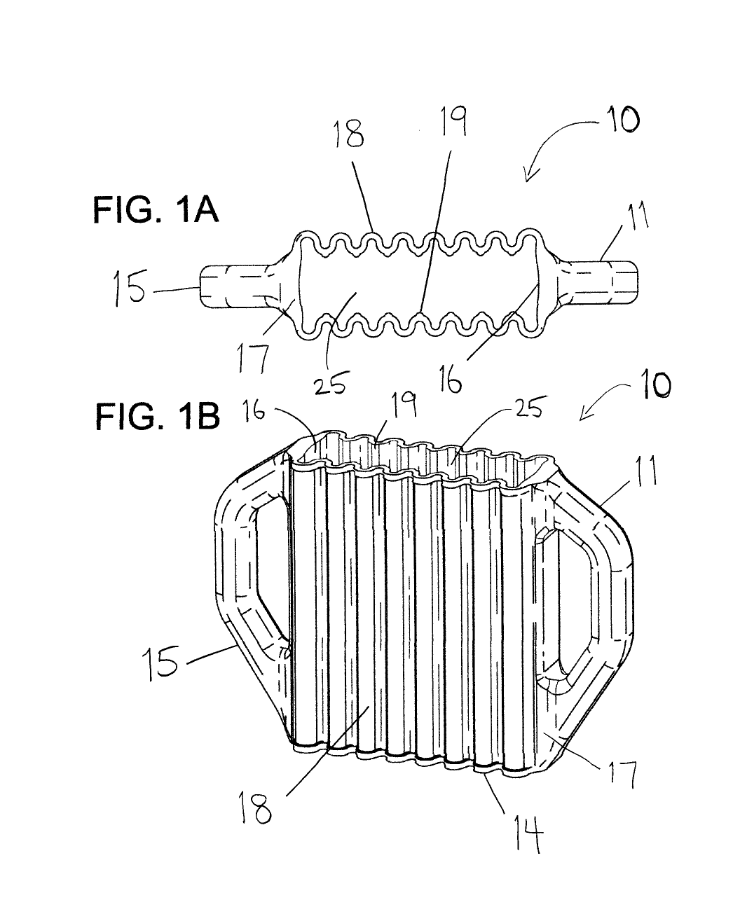

FIG. 1A shows a top end view of the adaptable sleeve (10), and FIG. 1B shows a top isometric view of the adaptable sleeve (10). As illustrated in FIGS. 1A and 1B the adaptable sleeve (10) is shown including a protrusion or a first handle (11) connected to a region of thicker material, region of stiffer material or rigid torsional support section (17), with an essentially flat, non-fluted or smooth interior facing support surface (16). The rigid torsional support section (17) connects to two fluted wall, accordion wall sections or corrugated sleeve wall sections (18) with raised ribs or axial ridges (19) positioned at each interior facing peak or inner most portion of the flutes of the corrugated sleeve wall section (18). The corrugated sleeve wall sections (18) connect to a second opposing rigid torsional support section (17) and second handle (15) to form a continuous tubular or hollow adaptable sleeve (10) where a top first opening (25) and a lower second opening (27 not shown directly), are each coextensively surrounded by an edge reinforcing lip (14), the openings being configured to receive various containers (not shown). The axial ridges (19) are continuous along the flute peaks from the first opening (25) to the second opening (27 not shown directly) As described above, the adaptable sleeve may be made out of any suitable material, however, in certain embodiments, such as that illustrated in FIG. 1A and FIG. 1B, the adaptable sleeve (10) is fabricated from silicone, e.g., compression molded from a single piece of 100% silicone.

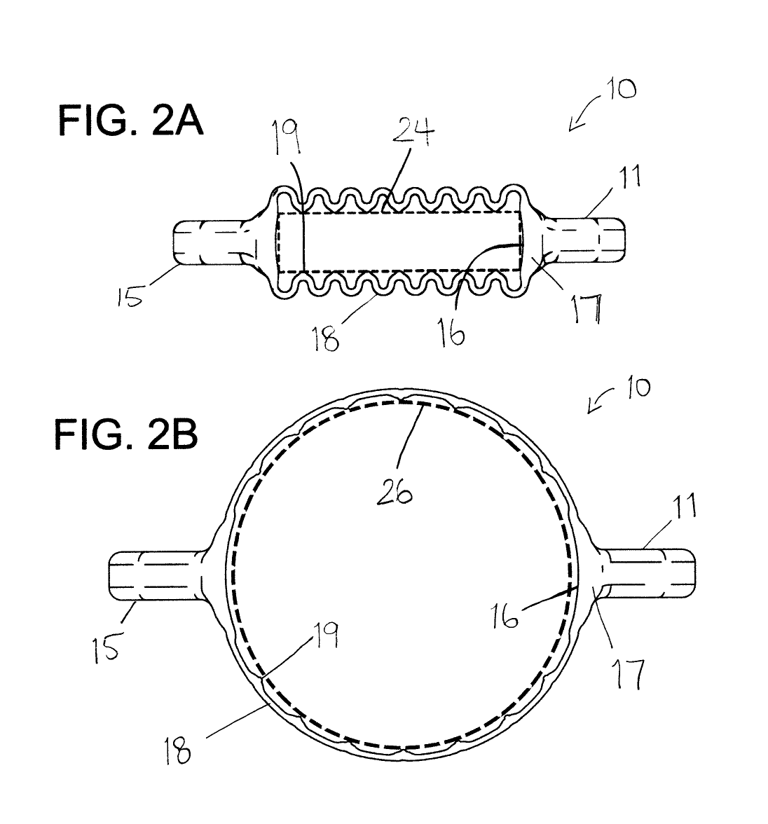

FIG. 2A shows a top end view of the adaptable sleeve (10) in a relaxed, initial state and minimum interior opening perimeter (24), and FIG. 2B shows a top end view of the same adaptable sleeve (10) in an expanded state and its maximum interior opening perimeter (26). The expansion and expandability of the sleeve illustrated in FIG. 2A and FIG. 2B, along with the axial ridges (19) allow the adaptable sleeve (10) to be easily slid either down over the top portion of a container downwardly to a preferred position or from the bottom portion of a container upwardly to a preferred position; whichever is more suitable for the user given a container's shape, presence of lid and contents.

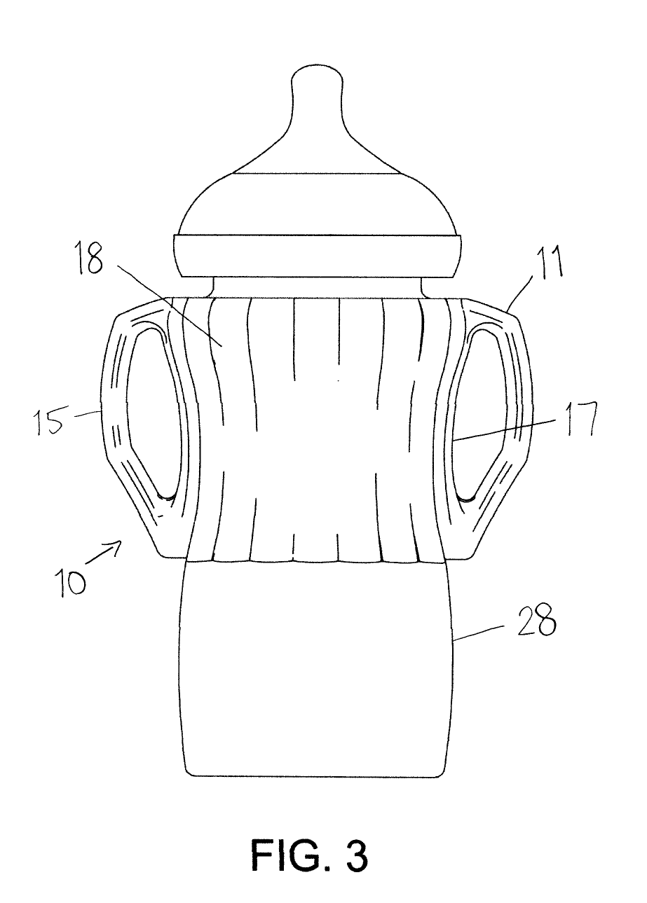

FIG. 3 illustrates an embodiment of the adaptable sleeve (10) installed on a glass infant feeding bottle (28). The displacement of the sleeve from its original relaxed shape due to the insertion of the container results in the creation of circumferential tension within the structure of the corrugated wall sleeve section (18). The corrugated sleeve wall sections (18) and rigid torsional support sections (17) conform to the roughly hourglass shape of the glass infant feeding bottle (28) allowing for the axial ridges (19 not shown) and smooth interior facing support surfaces (16 not shown) to contact the container. The contact, circumferential tension and resulting friction retain the container within the adaptable sleeve (10). The rigid torsional support sections (17) and smooth interior facing support surfaces (16) are in contact with the exterior of the container and provide resistance to torsional forces applied to the handle elements (11 and 15) during use, maintaining the general shape of the adaptable sleeve (10) and handles (11 and 15) and resulting positive control of the container.

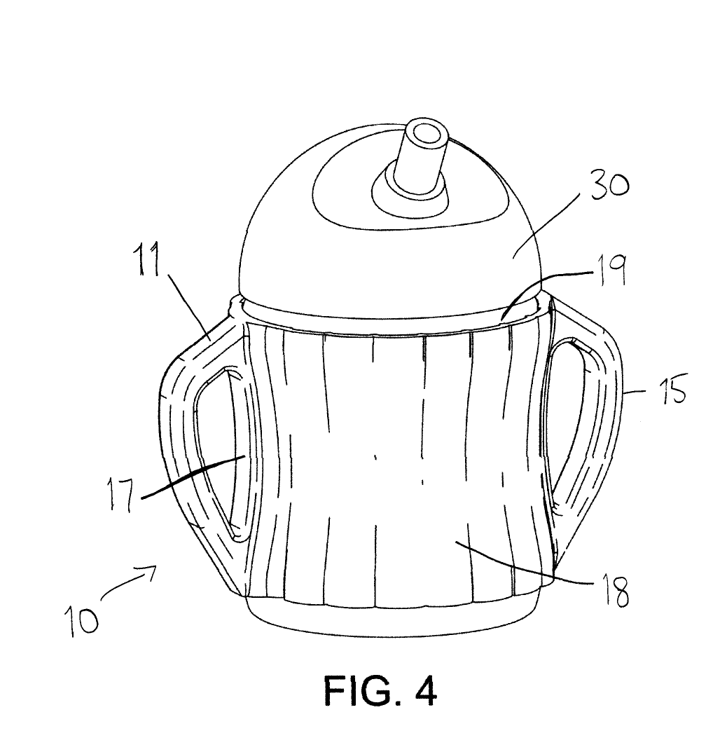

FIG. 4 shows an embodiment of the adaptable sleeve (10) installed on a plastic travel cup with drinking straw (29). The displacement of the sleeve from its original shape due to the inserted container results in the creation of circumferential tension within the structure of the corrugated wall sleeve section (18). As a result of the circumferential tensions, the corrugated sleeve wall sections (18) and rigid torsional support sections (17) conform to the roughly cylindrical shape of the plastic travel cup with drinking straw (29) allowing for the axial ridges (19 not shown) and smooth interior facing support surfaces (16 not shown) to contact the container. The contact, circumferential tension and resulting friction retain the container within the adaptable sleeve (10). The rigid torsional support sections (17) and smooth interior facing support surfaces (16) are in contact with the exterior of the container and provide resistance to torsional forces applied to the handle elements (11 and 15) during use, maintaining the general shape of the adaptable sleeve (10) and handles (11 and 15) and resulting positive control of the container.

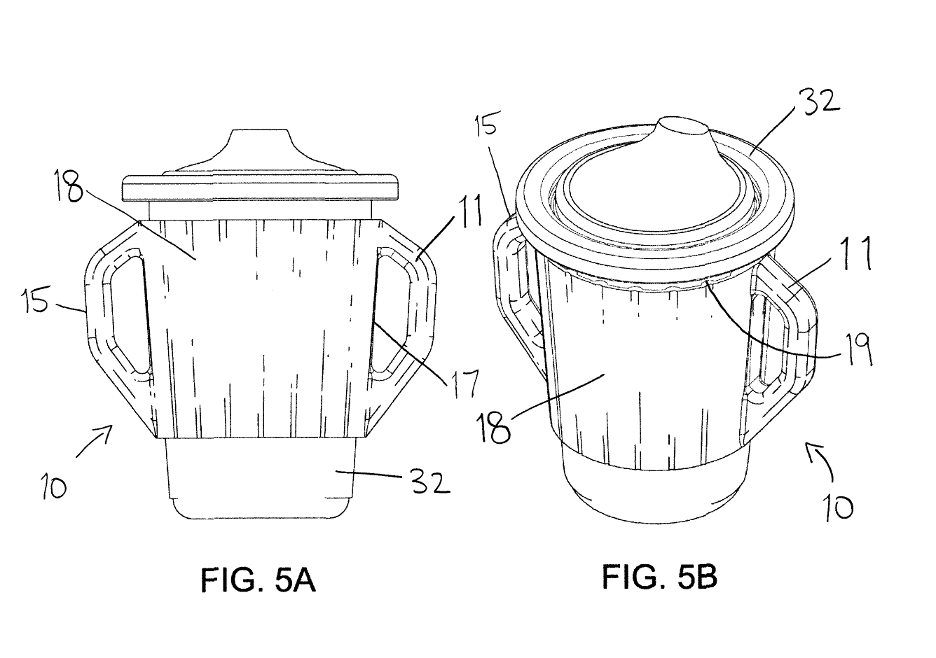

FIG. 5A and FIG. 5B illustrates a side view and a top isometric view of an embodiment of the adaptable sleeve (10) installed on a tapered plastic sippy cup (31). The displacement of the sleeve from its original relaxed shape due to the insertion of the plastic sippy cup (31) results in the creation of circumferential tension within the structure of the corrugated wall sleeve section (18). The corrugated sleeve wall sections (18) and rigid torsional support sections (17) conform to the conical shape of the tapered plastic sippy cup (31) allowing for the axial ridges (19 not shown) and smooth interior facing support surfaces (16 not shown) to contact and retain the container through frictional forces. The contact, circumferential tension and resulting friction retain the container within the adaptable sleeve (10). The rigid torsional support sections (17) and smooth interior facing support surfaces (16) are in contact with the exterior of the container and provide resistance to torsional forces applied to the handle elements (11 and 15) during use, maintaining the general shape of the adaptable sleeve (10) and handles (11 and 15) and resulting positive control of the container.

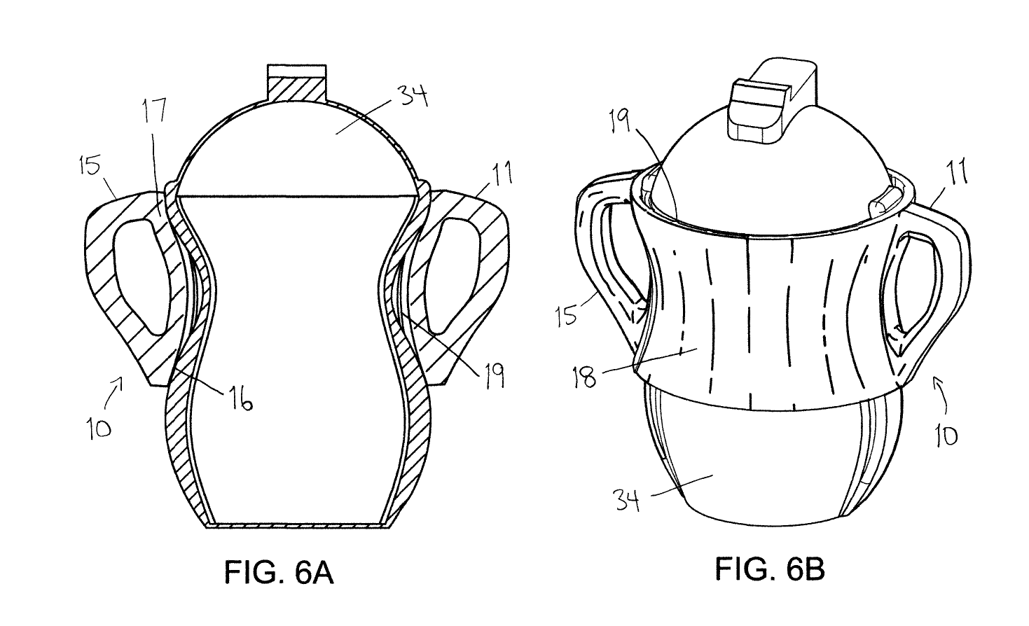

FIG. 6A and FIG. 6B shows a cross sectional, cutaway view and top isometric view of an embodiment of the adaptable sleeve (10) installed on an elliptical hourglass travel cup (33). The displacement of the sleeve from its original relaxed shape due to the insertion of the elliptical hourglass travel cup (33) results in the creation of circumferential tension within the structure of the corrugated wall sleeve section (18). The corrugated sleeve wall sections (18) and rigid torsional support sections (17) conform to the elliptical hourglass travel cup (33) however due to the aggressive curvature and small central diameter of the hourglass shape of the container the central inner, circumferential perimeter of the adaptable sleeve (10) does not contact the exterior surface of the container. The axial ridges (19) and smooth interior facing support surfaces (16) contact and retain the container by the contact areas near the top and bottom circumferential perimeters of the adaptable sleeve (10). The rigid torsional support sections (17) and corrugated sleeve wall sections (18) and axial ridges (19) span the central circumferential perimeter where the adaptable sleeve (10) does not fully contact the elliptical hourglass travel cup (22) maintaining the structure and position of the adaptable sleeve (10), handles (11 and 15) and positive control of the container.

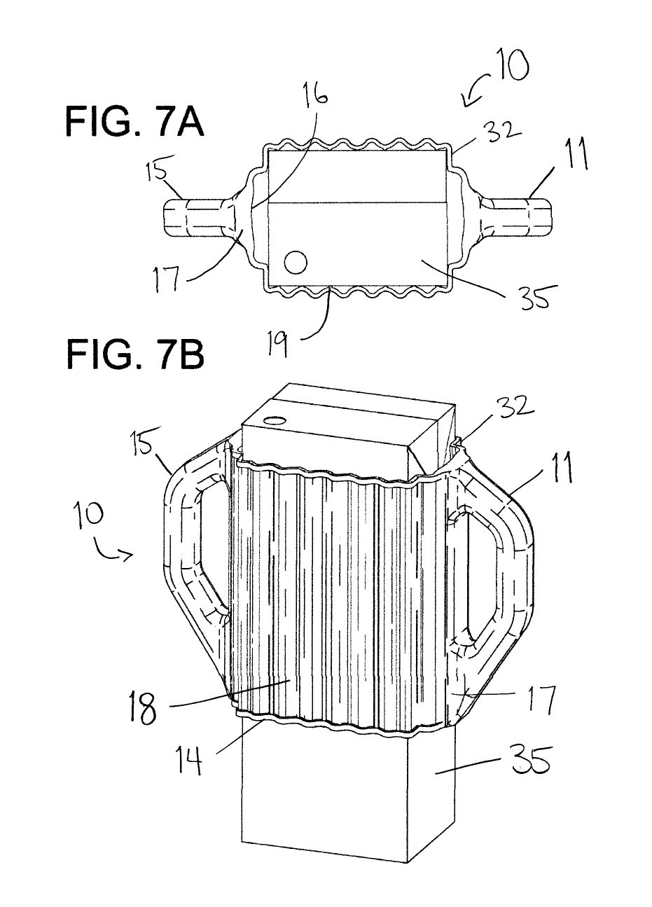

FIG. 7A and FIG. 7B illustrates a top view and a top isometric view of an embodiment of the adaptable sleeve (10) installed on a rectangular juice box container (34). The displacement of the sleeve from its original relaxed shape by the rectangular juice box container (34) creates tension in the sleeve pulling the handles (11 and 15) inwards towards the side s of the container. The corrugated sleeve wall sections (18) conform to the shape of the rectangular juice box container (34). The outer flutes (32) of the corrugated sleeve wall flatten against the exterior surface of the rectangular juice box container (34) edges, forming a smooth interior surface to retain and support the container by means of friction. For this particular container, the rigid torsional support sections (17) are offset from the container surface, providing adequate positive control of the container. It should be clear to those skilled in the art that the illustrated embodiment of the adaptable sleeve (10) is configured to receive a range of varying shapes and sizes of container.

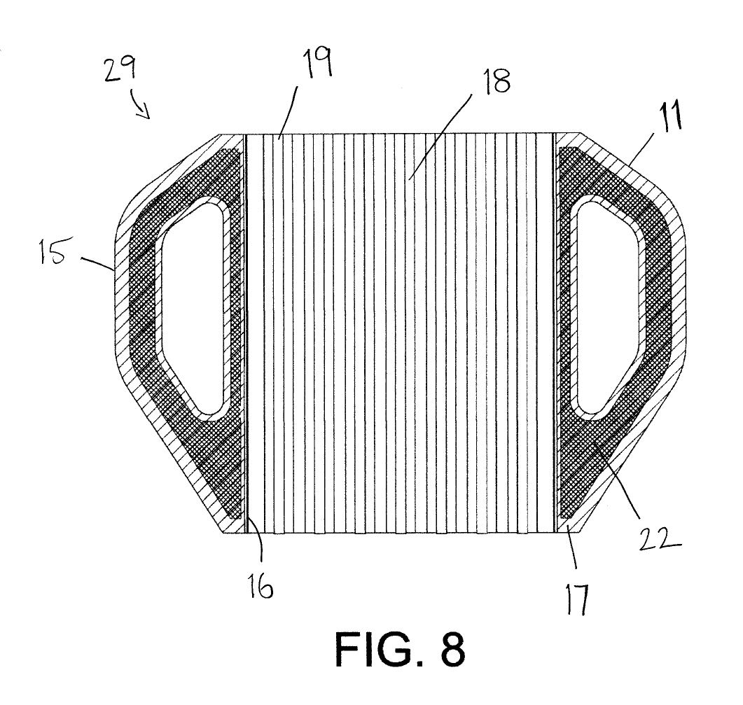

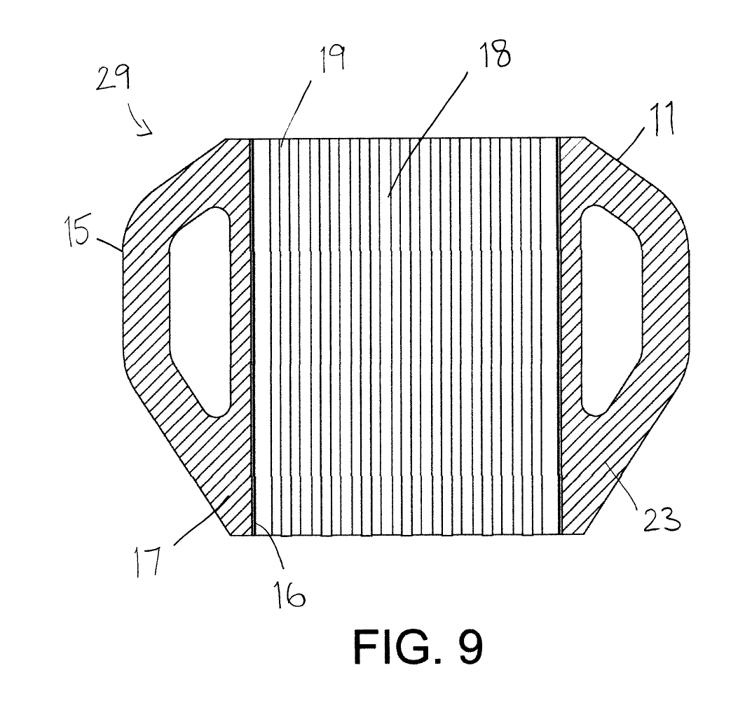

In certain embodiments the adaptable sleeve (10) may include elements to stiffen the protrusion elements such as that shown in FIG. 8 and FIG. 9 resulting in a hybrid adaptable sleeve (29). In FIG. 8 a fully encapsulated rigid structure or overmolded stiffer internal material or internal stiffening element (22) may be included to maintain the shape of the handle elements (11 and 15) under load and distribute load to the rigid torsional support section (17) and smooth interior facing support surface (16) to the container surface resulting in a hybrid adaptable sleeve (29). In FIG. 9. a stiffer or higher durometer elastomer may be used to manufacture a unitary hybrid adaptable sleeve (29) structure comprising two durometers of similar elastomer; a lower durometer, higher elasticity corrugated sleeve wall sections (18) and smooth interior facing support surfaces (16) and higher durometer (23) handle elements (11 and 15) and rigid torsional support sections (17). The stiffer protrusion and supporting structures adding further positive control of a container and hybrid adaptable sleeve (29).

In certain embodiments the adaptable sleeve (10) may include elements to limit axial elongation and deformation by manufacturing the corrugated sleeve wall sections (18) in a low durometer elastomer and the axial ridges (19) in a higher durometer elastomer whereby further biasing the adaptable sleeve (10) for radial expansion and limiting axial elongation. In certain embodiments the limiting of axial elongation is beneficial, reducing undesired snagging and deformation of the sleeve on protruding container geometry during sliding installation of the adaptable sleeve (10) onto a container.

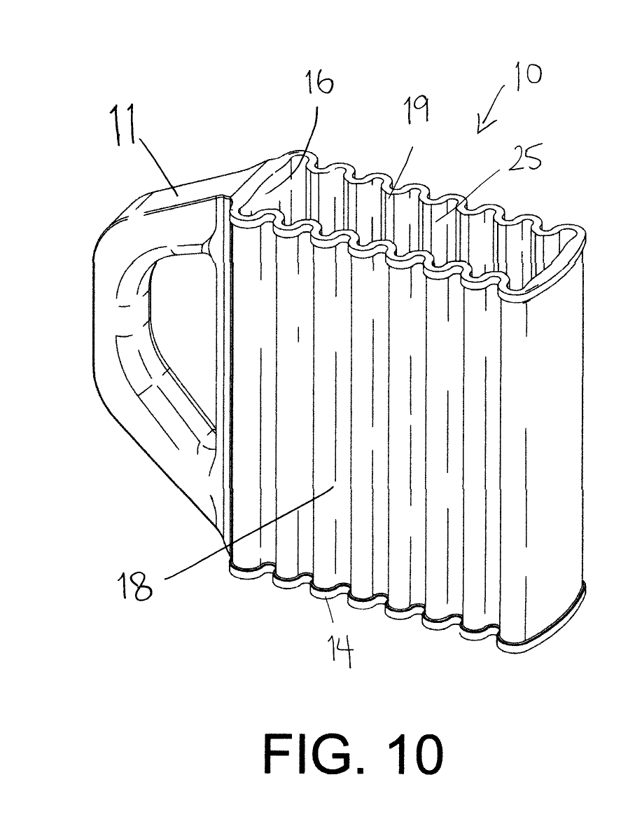

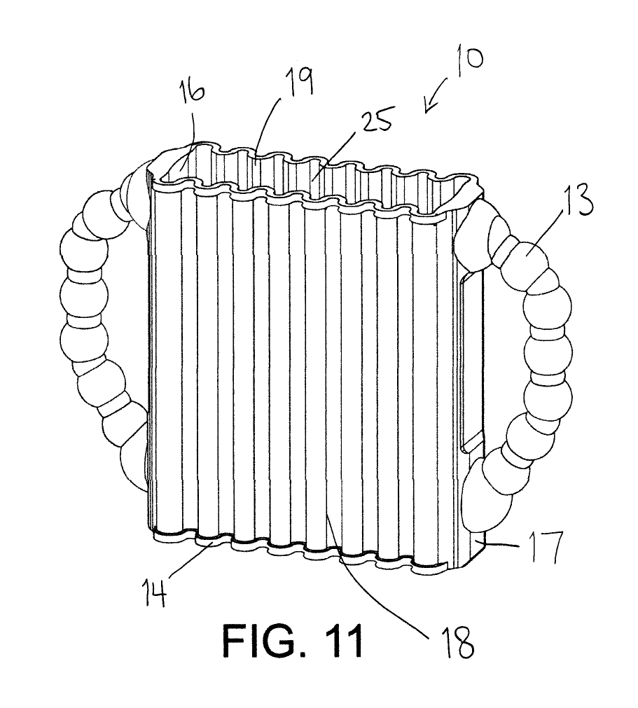

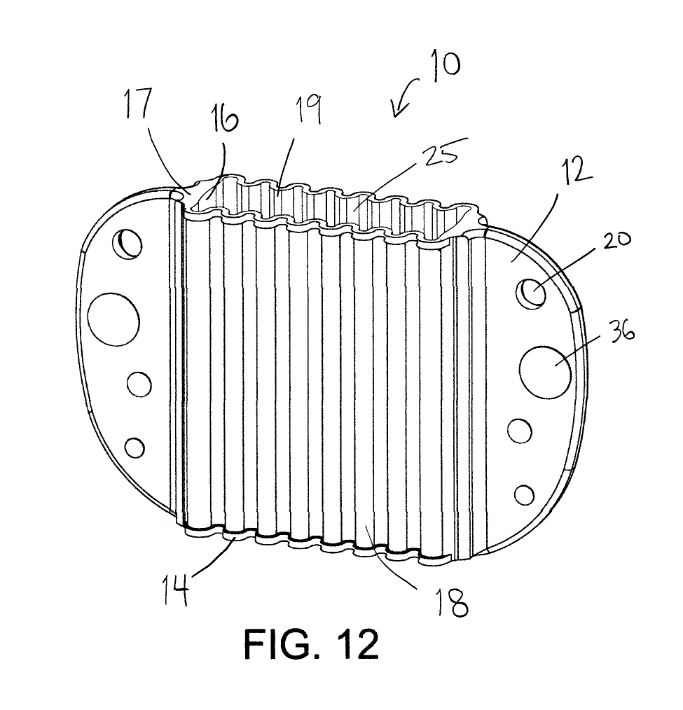

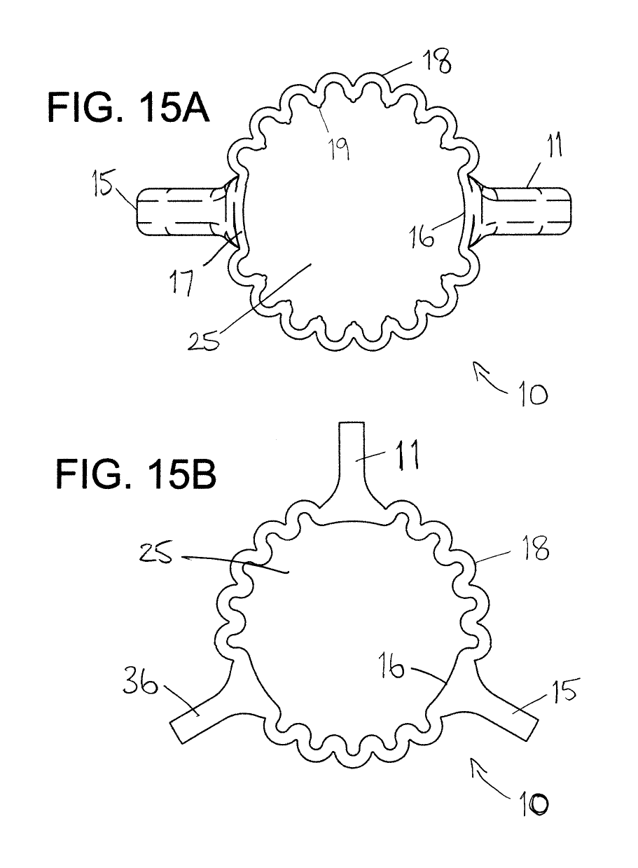

In certain embodiments the adaptable sleeve (10) may include protrusions or handle configurations may take on a variety of forms and designs, some with auxiliary functionality as seen in FIG. 10, FIG. 11, FIG. 12 FIG. 15B.

FIG. 10 shows an isometric top view of an embodiment of a single handled adaptable sleeve (10) with a rigid first handle (11) whereby the design is aesthetically appealing to adults.

FIG. 11 illustrates an isometric top view of an embodiment of a two handled adaptable sleeve (10) configured for infants where the handle geometry is also configured as a teething chew accessory (13). The adaptable sleeve may be made out of any suitable material, however in certain embodiments, such as that illustrated in FIG. 11, the adaptable sleeve (10) and teething chew accessory handles (13) are fabricated from FDA approved silicone, e.g., compression molded from a single piece of 100% pure silicone free of harmful chemicals; specifically bisphenol A, phthalates, polyvinyl chlorides and lead and safe for dishwashers, microwave use, and freezers.

FIG. 12 shows an isometric top view of an embodiment of an adaptable sleeve (10) with two flange, rib type protrusions (12) with a hole (20) for securing the adaptable sleeve (10) and surface texture features (36) such as ribs, domes, ridges or bumps to aid grasping. The solid construction of the flange, rib type protrusion (12) further stiffens the rigid torsional support section (17) for positive control of the container. Similarly, certain embodiments may be configured such that the flange, rib type protrusions (12) are shaped to resemble animals, characters, art or imagery so to appeal to children, e.g., the rib type protrusions are shaped like elephant ears and a silkscreen of an elephant face applied to the corrugated wall sleeve (18).

FIG. 15B shows a top view of an embodiment of an adaptable sleeve (10) with a first handle (11) a second handle (15) and a third handle (36). In certain embodiments the protrusions may be plural protrusions and a combination of designs and styles, e.g., where two handles may be configured as conventional handles and a third protrusion is configured as a dedicated teething chew or as a dedicated loop or ring for securing or tethering the sleeve.

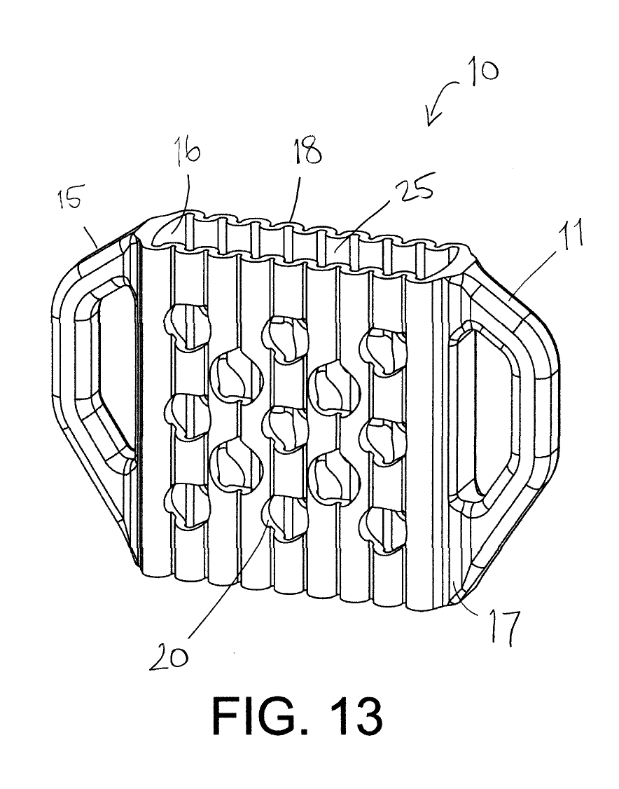

In certain embodiments, as illustrated in FIG. 13, the adaptable sleeve (10) is comprised of a corrugated sleeve wall section (18) with holes, cutaways or shaping, viewing vents (38) placed specifically in the central portion of the sleeve surface to allow viewing of the contents of the container and greater conforming of the sleeve to the container surface.

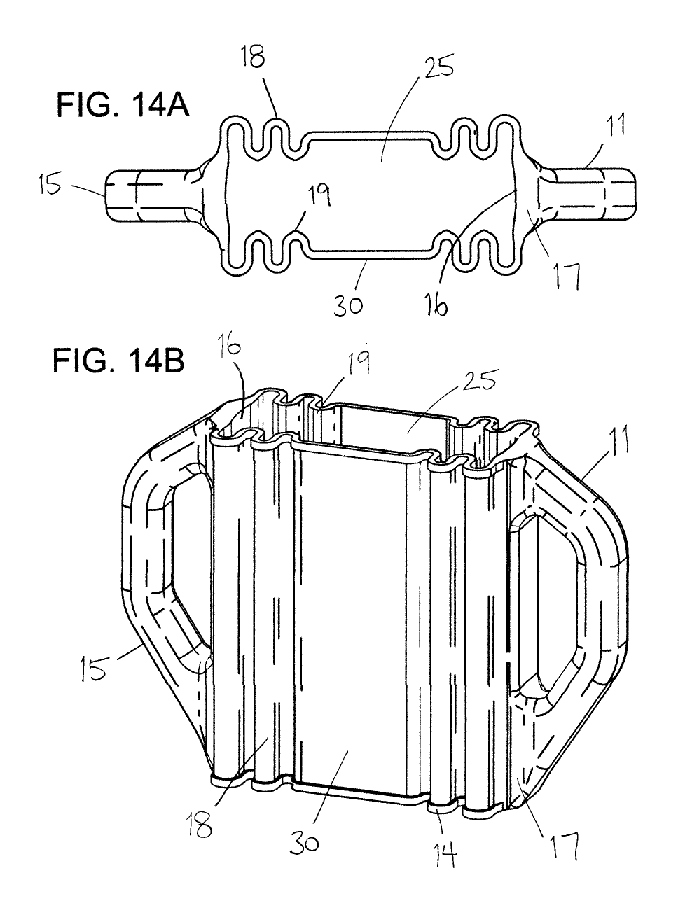

In certain embodiments, as illustrated in FIG. 14A and FIG. 14B, the adaptable sleeve (10) is comprised of a corrugated sleeve wall section (18) with additional flat wall sections (30) configured for the inclusion of aesthetic design elements such as silk screening, embossed or molded designs, logos, art or imagery. In certain embodiments, such as the case with FIG. 14, the corrugated sleeve wall sections (18) may be configured with flutes of varying or increased amplitudes or undulations to compensate for the reduced number of flutes resulting from the additional flat wall sections (30).

The adaptable sleeve (10) may fabricated out of any suitable material, however, in certain embodiments, such as that illustrated in FIG. 1 and FIG. 2, the adaptable sleeve (10) is fabricated from 100% silicone of durometer Shore 30A, it may also be fabricated of 100% silicone or combination of silicones ranging in durometer of Shore 20A or up to Shore 80A.

The peak to peak amplitude and wall thickness of the flutes of the corrugated sleeve wall (18) may be configured to expand and receive containers ranging in circumferential area of approximately 2 sqin to 11 sqin and beyond. In FIG. 2B the maximum interior opening perimeter (26) is illustrated as a circular opening, the opening may take on various shapes, conforming to the shape of container it is fitted to.

The wall thickness of the corrugated sleeve wall (18,) as the embodiment of the adaptable sleeve (10) is illustrated in FIG. 1B, is roughly 0.0375″ thick, with the edge reinforcing lip (14) roughly 0.05875″ thick and roughly 0.05875″ tall. The height dimension between the first opening (25) and second opening (27 not directly shown) of the adaptable sleeve is roughly 2.75″ tall. The width between the opposing smooth interior facing support surfaces (16) is roughly 2.25″. The total width between the outer surfaces of the first and second handles (11 and 15) roughly 4″. The minimum width from a top view of the first and second handles is roughly 0.375″. The minimum thickness from a top view of the rigid torsional support section (17) is roughly 0.14″ thick. All edges of the adaptable sleeve are typically beveled or rounded to avoid snagging and tearing.

The adaptable sleeve (10), may be compression or injection mold manufactured or combination of these methods in an embodiment such as a relaxed flat configuration such as that illustrated in FIG. 2A, or round configuration such as that illustrated in FIG. 15A. The adaptable sleeve (10) and smaller first opening (25) and second opening (27 not directly visible) as illustrated in FIG. 2A results in increased deformation from the relaxed state of the adaptable sleeve (10) when a container is inserted whereby providing improved retention of the container.

The manner of using the adaptable sleeve is typically performed with two hands. During typical installation of the adaptable sleeve (10) onto a container, a user will place a container on a flat and stable surface. Then a user will place their hands into the second opening (27) from the bottom access of the sleeve upwards into the interior of the sleeve towards the first opening (25) The user will typically place both hands and fingers onto each smooth interior facing support surface (16) and stretch the first handle (11) and second handle (15) outwardly or horizontally or circumferentially away from one another, whereby expanding corrugated sleeve wall section (18), the second opening (27 not directly shown), and first opening (25) to receive the container. The user will slide adaptable sleeve (10) down over top of a container, first with the second opening (27) sliding downwards over the container and the first opening (25) trailing. Typically the user's fingers and hands block contact between the smooth interior facing support surfaces (16) from substantially contacting the container exterior surface during sliding installation. The axial ridges (19) in conjunction with the corrugated wall sleeve sections (18) maintain a reduced and essentially consistent surface area of contact between the adaptable sleeve and the container exterior surface during sliding installation. When the adaptable sleeve (10) is at the desired location on the container the user removes their hands and fingers typically releasing the tension within the structure of the expanded sleeve and engaging the smooth interior facing support surfaces (16) with the exterior of the container. The combination of these elements and their function allow a user to install and remove the adaptable sleeve (10) with relative ease while still maintaining sufficient contact area and friction to retain the container. Thus easily adding safe, reusable, easily cleanable handles to a container of varying shape, size and material composition.

As summarized above, the adaptable sleeve invention provides improved grasping and control; whereby providing a solution to easily add handles to a container of at least varying shape, size and material composition. In certain embodiments, the adaptable sleeve is configured to expand as necessary to be fitted to a container and conform to the container shape. The container perimeter shape can be rectangular, triangular, elliptical, round, tapered, hourglass, ring or other complex shapes or combination of shapes. In certain embodiments the adaptable sleeve is comprised of essentially silicone providing a reusable, chemically stable, safe and easily cleanable solution, and also suitable for teething pain relief in infants.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the invention. All such modifications are intended to be within the scope of the claims appended hereto.

What is claimed is:

1. An adaptable sleeve for containers comprising:
a) at least a first opening, adapted for receiving said containers;
b) an expandable sleeve, configured for receiving said containers, wherein said expandable sleeve comprises essentially elastomer; and
c) at least one protrusion attached to said expandable sleeve.

2. The adaptable sleeve according to claim 1, wherein said adaptable sleeve comprises a second opening that is separated from said first opening by said expandable sleeve.

3. The adaptable sleeve according to claim 1, wherein said expandable sleeve comprises a corrugated sleeve wall.

4. The adaptable sleeve according to claim 1, wherein said expandable sleeve comprises essentially silicone.

5. The adaptable sleeve according to claim 1, wherein said protrusion or plurality of protrusions comprises gripping elements.

6. The adaptable sleeve according to claim 3, wherein said corrugated sleeve wall further comprises essentially silicone.

7. The adaptable sleeve according to claim 3, wherein said corrugated sleeve wall comprises a plurality of elastic flutes, further comprising protruding axial ridges on the surface of and parallel with the interior facing peaks of said elastic flutes.

8. The adaptable sleeve according to claim 3 and claim 5, wherein said expandable sleeve comprises at least one interior facing, smooth wall section interposing and connected to said corrugated sleeve wall, configured to support said gripping elements.

9. The adaptable sleeve according to claim 8, comprising essentially silicone durometer rating Shore 20A to Shore 40A.

10. The adaptable sleeve according to claim 5, wherein said gripping elements comprises rigid material of at least one of: increased material thickness, elastomer of increased durometer, material of substantially increased stiffness or combination thereof.

11. The adaptable sleeve according to claim 5, wherein said gripping element comprises a loop, a handle, a rib and a flange or combination thereof.

12. The adaptable sleeve according to claim 5, wherein said gripping element comprises a rigid internal structure of essentially plastic, metal or substantially higher durometer elastomer.

13. The adaptable sleeve according to claim 5, wherein said gripping element comprises an embedded rigid structure encapsulated by essentially silicone.

14. The adaptable sleeve according to claim 1, wherein said protrusion or plurality of protrusions are configured as teething chew elements for infants.

15. A protective, adaptable sleeve for containers comprising:
a) at least a first opening, adapted for receiving said containers; and
b) an expandable corrugated sleeve wall, configured for receiving a range of containers of at least one of substantially varying: shape, size, and material composition.

16. The protective, adaptable sleeve according to claim 15, wherein said expandable, corrugated sleeve wall comprises a plurality of flutes and voids configured to surround the exterior of said containers.

17. The adaptable, protective sleeve according to claim 15, wherein said protective, adaptable sleeve comprises elastomer.

18. The adaptable, protective sleeve according to claim 15, wherein said protective, adaptable sleeve comprises at least one gripping element.
